(19) United States
(12) Patent Application Publication
(10) Pub. No.: US 2025/0165654 A1
(43) Pub. Date: May 22, 2025

(54) Method for Operating Control Software and Arrangement having a Computer System

(71) Applicant: Siemens Aktiengesellschaft, Muenchen (DE)

(72) Inventors: Ronny HOG, Kümmersbruck (DE); Julia SCHWEIGER, Hirschau (DE); Sebastian SCHÖTZ, Hahnbach (DE); Markus WALTER, Bamberg (DE)

(21) Appl. No.: 18/950,802

(22) Filed: Nov. 18, 2024

(30) Foreign Application Priority Data
Nov. 20, 2023 (EP) 23210792

(51) Int. Cl. G06F 21/64; G06F 21/57; G06F 21/60

(52) U.S. Cl. CPC G06F 21/64; G06F 21/57; G06F 21/606

(57) ABSTRACT

A method for operating control software to control a process, wherein the control software is executed within a runtime environment on a computer system and a security program is loaded into a load memory so as to run in the control software, where a checksum of the program code of the security program is stored in a network subscriber that is connected to the computer system via a communication network, where a load memory checksum is generated during startup of the control software in the runtime environment via the program code of the security program, which is stored in the load memory, where the previously stored checksum is queried by the network subscriber and compared with the load memory checksum, and where execution of the security program in the control software is terminated in the event of a discrepancy.

### BACKGROUND OF THE INVENTION

### 1. Field of the Invention

The invention relates to the field of security-related controllers, particularly control software and, more particularly, relates to a method for operating control software so as to control a process, where the control software is executed within a runtime environment on a computer system, and a security program is loaded into a load memory so as to execute in the control software.

### 2. Description of the Related Art

Conventional controllers are currently based on a hardware platform, a special electronic substructure, i.e., a programmable logic controller (PLC). If there has recently been talk of virtual controllers or software controllers, then this also requires hardware for execution, but the hardware can now be completely abstracted. This means that the executed soft PLC no longer needs to know which device it is running on.

These devices can still be dedicated control devices, such as multifunctional control platforms or industrial PCs, or edge computing platforms, which are increasingly found in control networks of machine and plant operators, or even cloud computing platforms are used. The abstraction of the hardware by containers or hypervisors is decisive. Thereupon, the soft PLC is “deployed” with standard means or orchestrated by a tool, e.g., an installation, as in the case of software-based control, is omitted.

Programmable logic controllers must be designed such that they meet functional security in accordance with the requirements of the EN 61508 standard. In the case of security-related systems, such as programmable logic controllers for critical processes that contain electrical, electronic or programmable electronic components and whose failure poses a significant risk to humans or the environment, these must be designed for a special guarantee of security. The following should be mentioned as examples of applications that require increased security: Nuclear power plants, control technology for systems with safety significance, railway applications, telecommunication technology, signal technology and data processing systems, chemical processes, but also, for example, small systems, such as a punch for punching out sheet metal parts.

In the case of current security controllers (for example, SIMATIC S7-1511 F), it must be ensured that the security controller starts with the current and valid security program during startup after a network off/on or stop/run transition. In the case of special failsafe PLCs as a single device, their development and thus the hardware structure is the responsibility of the manufacturer. Consequently, the error could be discovered by corresponding tests of the firmware, which has direct access to the hardware and thus to the charging memory, in the event of a malfunction.

Conventional security controllers are discussed in EP 2 284 771 B1 and EP 2 241 953 B1.

### SUMMARY OF THE INVENTION

It is an object of the present invention to provide an arrangement and method that ensure the correct security program in the control software is also executed with a virtual controller.

This and other objects and advantages are achieved in accordance with the invention by a method in which a checksum of program code of a security program is stored in a network subscriber that is connected to a computer system via a communication network, where a load memory checksum is generated during a startup of the control software in the runtime environment via the program code of the security program, which is stored in the load memory. Furthermore, the previously stored checksum is queried by the network subscriber and compared with the load memory checksum, where execution of the security program in the control software is stopped or terminated in the event of a discrepancy.

In the context of the invention, a runtime environment is to be understood as an execution environment or a execution environment for other programs or apps. The runtime environment then represents a platform for the respective program and allows it to execute on the platform for which the runtime environment has been made, which can occur anywhere on any virtual machine.

After downloading the security program to a hardware-independent security controller, such as to a virtual machine, a mechanism is triggered that stores the checksum via the communication network on another network subscriber. The runtime environment, which is to be regarded as the classic firmware in the previously used singular hardware, is now configured so as to request the checksum from the connected network participant via the communication network. The possible error that the current security program does not run on a virtual controller can now be secured against, because the checksum is retrieved from a location that has been predefined. Here, it is crucial for the unit that makes the later comparison of the checksums to have knowledge of the storage location.

Furthermore, in the context of the invention, checksums are to be understood as values that are generated from the transmitted data itself, before and after the transmission. They are used to detect falsifications of the data.

In order to achieve maximum flexibility, in accordance with the method, instances are generated by the runtime environment on the computer system or on other computer systems, upon which control software for controlling a process is executed in each case, and a security program is loaded into a load memory, which is allocated to the respective instance, so as to execute in the respective control software, where a utility is operated that manages a storage of the respective checksums of the respective program codes of the respective security programs, where the respective checksum is requested via the utility during a startup of the respective control software in the respective instance, and a load memory checksum is generated in the respective instance via the program code of the respective security program, which is stored in the associated load memory, and compared with the checksums that are queried via the utility, and where execution of the respective security program in the respective control software is stopped or terminated in the event of a discrepancy.

Advantageously, a unique identification number is used in the utility in the management of checksums of a plurality of program codes of the respective security programs for the respective control software. This has the advantage that if a plurality of security control instances are to be stored, then a unique ID (for example, a serial number) is stored in addition to the checksum. It is also important that the storage devices of the security controller and the utility are independent of each other.

When the instance of the safety controller starts up, the stored checksum (possibly with ID) is queried in the utility. Subsequently, a checksum is formed by the firmware of the security controller over the entire safety program in the load memory and compared with the returned checksum. Only in the case of equality will the execution of the security program be continued. Otherwise, the execution is stopped/terminated.

For further security, in particular if the selected network subscriber is not reachable, it is advantageous if the checksum of the program code of the security program is copied and a redundant storage is set up, and the checksum (FCC-con) or a checksum copy (FCC′-con) is stored on different network subscribers via the communication network.

The operation of the computer system as a multifunctional control platform, as an industrial PC, as an edge computing platform or as a cloud computing platform increases flexibility many times over.

A project designer or a commissioner of an industrial plant can now connect to the computer system using an engineering system for downloading the security program, where the checksum of the program code of the security program can then be stored either by the engineering system or by the runtime environment.

In order to be able to guarantee security for humans and machines, the control software is operated with the security program so as to control a process as a controller that is designed for functional security, and security modules are operated in the control software having the security program in order to ensure the processes that are required by the control software for functional security.

The objects and advantages are also achieved in accordance with the invention by an arrangement that has a computer system comprising a runtime environment that is configured so as to execute control software to control a process, a load memory that is configured to hold a security program for execution in the control software, a network subscriber that is connected to the computer system via a communication network, and that is provided with a storage area in which a checksum of the program code of the security program is stored, a program identifier that is configured to generate a load memory checksum during a startup of the control software via the program code of the security program, which is stored in the load memory, and to query the checksum that is previously stored in the network subscriber and to compare the checksum with the load memory checksum, further configured to output an error signal that stops the security program from being executed in the control software in the event of a discrepancy.

Until now, fail-safe programmable logic controllers could only be executed on dedicated hardware. By introducing this solution, it is possible to ensure the execution of a failsafe PLC on any networked hardware.

In order to automate different sub-tasks or sub-processes, the arrangement has a first instance of the runtime environment on the computer system and a second instance of the runtime environment on the computer system or on a further computer system, where the instances are configured to each hold control software for controlling a process, in which a security program can in turn be loaded in each case. The arrangement further has a first load memory and a second load memory in which the respective control software is loaded, where the runtime environment or its instances is/are configured to load the security programs into the control software during a startup, and further has a utility that is configured so as to manage a storage of the respective checksums of the respective program codes of the respective security programs, and further configured to request the respective checksum during a startup of the respective control software in the respective instance, where the respective instances are configured to generate a load memory checksum via the program code of the respective security program stored in the associated load memory, and to compare with the checksum that is queried via the utility, and wherein execution of the respective security program in the respective control software is stopped or stopped in the event of a discrepancy.

In the arrangement, in the management of checksums of a plurality of program codes, a utility is configured to allocate a unique identification number to the respective security programs for the respective control software.

If security control instances are to be stored, then a unique ID (for example, a serial number) must be stored in addition to the checksum. The storage devices of the security controller and the utility, which can serve as a storage service, must be independent of each other.

When the instance of the safety controller starts up, the stored checksum (possibly with ID) is queried in the storage service. Subsequently, a checksum is formed by the firmware, in other words the runtime environment of the security controller over the entire safety program in the load memory and is compared with the returned checksum. Only in the case of equality will the execution of the security program be continued. Otherwise, the execution is stopped or terminated.

In order to increase availability, the arrangement also has a redundant storage in which a checksum copy of the checksum of the program code of the security program can be stored.

Advantageously, the computer system is formed as a multifunctional control platform, as an industrial PC, as an edge computing platform, or as a cloud computing platform.

The arrangement further has an engineering system that is configured to download the security program and/or to create the instances (A, B) in the computer system.

With regard to fulfilling the functional security, the control software is operated with the security program so as to control a process as a controller that is structured for functional security, and security modules are present in the control software having the security program to ensure the processes that are required by the control software for functional security.

The transfer of a security program to the load memory (for example, hard disk) usually occurs via a cache. Due to a software or hardware error, it is possible that the transfer only occurs in the cache, so that an old security program is present in the load memory (for example, hard disk). After a network off/on, however, the old security program could be loaded from the hard disk into the cache again and processed, where this mishandling is avoided by invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing illustrates an exemplary embodiment of the invention, in which:

FIG. 1 shows a computer system that is configured so as to execute control software in accordance with the invention;

FIG. 2 shows a program identification means that executes in a firmware for the control software in accordance with the invention;

FIG. 3 shows the computer system of FIG. 1 with an instance formation of control software or firmware instances for the control software;

FIG. 4 shows the generation and operation of a plurality of safety control instances with the supply via an engineering system in accordance with the invention; and

FIG. 5 is a flowchart of the method in accordance with the invention.

### DETAILED DESCRIPTION OF THE EXEMPLARY EMBODIMENTS

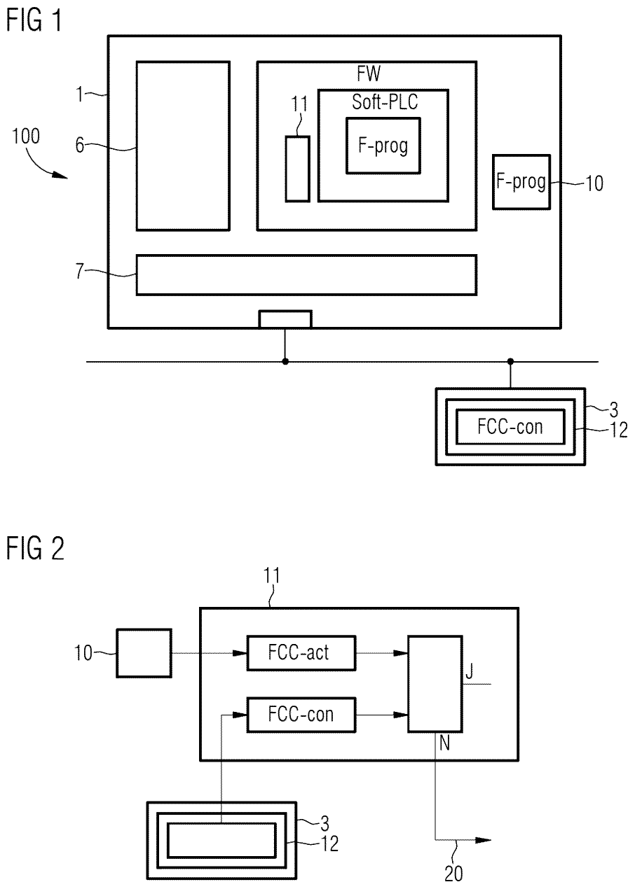

With reference to with FIG. 1, the arrangement 100 shown therein includes a computer system 1 having a runtime environment FW and another operating system 6, both of which are managed in the computer system 1 via a hypervisor 7. The runtime environment FW is configured to execute control software Soft-PLC so as to control a process.

A load memory 10 is configured to hold a security program F-Prog for running in the control software Soft-PLC. The runtime environment FW therefore simulates firmware for a software-based programmable logic controller within a computer system. The control software Soft-PLC is embedded in the runtime environment FW, and a security program F-Prog is in turn embedded in the control software Soft-PLC, which is configured to execute and control the process.

The computer system 1 is connected to a network subscriber 3 via a communication network 2. The network subscriber 3 is provided with a storage area 12 in which a checksum FCC-con of the program code of the security program F-Prog can be stored.

The runtime environment FW has a program identifier 11, which is configured to generate a load memory checksum FCC-act during a startup of the control software Soft-PLC via the program code of the security program F-Prog, which is stored in the load memory 10. In addition, the program identifier 11 is configured to query the checksum FCC-con that is previously stored in the network subscriber 3 and to compare it with the load memory checksum FCC-act. If the comparison results in a discrepancy, the program identifier 11 is further configured to output an error signal 20 that stops the security program F-Prog from being executed in the control software Soft-PLC.

The transfer of a security program to the load memory (for example, hard disk) usually occurs via a cache. Due to a software or hardware error, it is possible that the transfer only occurs in the cache, so that an old security program is present in the load memory 10 (for example, hard disk). Without the program identifier 11 in accordance with the invention and the storage on a further network subscriber, an error, which results from the fact that an old program is still located in the load memory 10 and thus an old program was loaded in the cache during a startup, could not be uncovered.

In general, it should be appreciated that after downloading the security program F-Prog to a hardware-independent security controller, a mechanism is triggered, either directly via an engineering system or via the runtime environment FW that is configured as firmware, which stores the checksum via a network communication on another network subscriber 3. If the software or the runtime environment FW then starts up with the control software Soft-PLC, the stored checksum is queried and then a checksum is formed in the load memory by the runtime environment FW over the entire security program F-Prog and compared with the returned checksum. Only in the case of equality is the execution of the security program continued, otherwise the execution is stopped or terminated.

Details of the program identifier 11 introduced with FIG. 1 are explained in more detail with FIG. 2, where during a program startup or, for example, after a network off/on, the program identifier 11 loads the security program F-Prog from the load memory 10 and forms a load memory checksum FCC-act over the entire program code of the security program F-Prog. In addition, the program identifier 11 is configured to retrieve the checksum FCC-con from the storage area 12 of the further network subscriber 3. A current checksum and the checksum of the configuration are now available in the program identifier 11 for a comparison. If the comparison is positive, then the procedure is continued via a yes branch J. If the comparison is negative, then an error signal 20 is generated via an N branch N. The error signal 20 is used to stop the startup of the security system or the security program F-Prog.

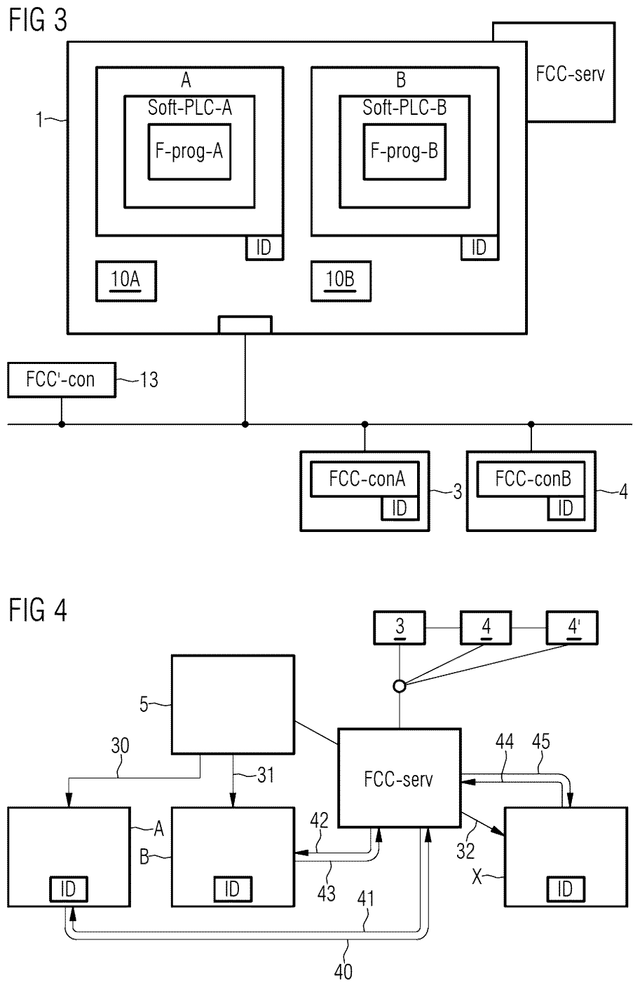

FIG. 3 is a illustration of an embodiment of the computer system 1 with program instances that are formed. In the computer system 1, a first instance A of the runtime environment FW and a second instance B of the runtime environment FW have been installed or implemented via an engineering system 5 (see FIG. 4). The instances A, B are configured to hold control software Soft-PLC-A, Soft-PLC-B for controlling a process. In the instances A, B or in the control software Soft-PLC-A on Soft-PLC-B, a security program F-Prog-A, F-Prog-B is in each case in turn loaded. For this purpose, the computer system 1 has a first load memory 10A and a second load memory 10B, in which the respective control software Soft-PLC-A, Soft-PLC-B is loaded.

The runtime environment FW or its first instance A and its second instance B is configured as shown in FIG. 2, in each case with a program identifier 11.

There is a utility FCC-Serv, which is configured to manage storage of the respective checksums FCC-con-A, FCC-con-B of the respective program codes of the respective security programs F-Prog-A, F-Prog-B. Here, either the utility FCC-Serv can assume the checking task or the program identifier 11 can do so. In any event, the respective checksum FCC-con-A, FCC-con-B is queried in the respective instance during a startup of the respective control software Soft-PLC-A, Soft-PLC-B.

In a similar manner to the behavior in accordance with FIG. 1, the respective instances A,B are configured to generate a load memory checksum FCC-act-A, FCC-act-B via the program code of the respective security program F-Prog-A, F-Prog-B that is stored in the associated load memory 10A, 10B. Now, either the utility FCC-serv can compare the queried checksums FCC-con-A, FCC-con-B with the current checksums FCC-act-A, FCC-act-B, but the comparison could also occur in the program identifier 11.

When managing the utility FCC-serv of multiple instances and checksums, it is advisable that an identification number ID is allocated to each instance.

In order to ensure possible redundancy, if the network subscriber 3 should fail once, a redundant storage 13 is provided in any further network subscriber. A checksum copy FCC′-con of the checksum FCC-con of the program code of the security program F-Prog is stored in this redundant storage 13 and can be queried.

FIG. 4 illustrates how instances can be generated and the programs can be downloaded via an engineering system 5. The engineering system 5 has, for example, generated a first instance A, a second instance B and an x-th instance X. The engineering system 5 loads the security program F-Prog-A into the first instance A via a download 30, the second security program F-Prog-B is loaded into the second instance B via a download 31, and it is then continued as desired until an x-th program is loaded into the x-th instance X via a download 32. Each instance A, B, X is now allocated a unique identification number ID. The utility FCC-Serv, which can also be installed as any app, is in turn connected to a network subscriber 3, a further network subscriber 4 and a further network subscriber 4′. The respective checksums are stored on these network subscribers. If, for example, the first instance A wants to start up with its security program, then the checksum is requested from the utility FCC-Serv via a query 40 of the checksum for the instance A. The utility FCC-Serv will return the checksum to the first instance A via a return delivery 41, and the latter can perform the comparison for equality of the checksums.

The second instance B also queries the utility FCC-Serv via a query 43 of the checksum for instance B with a query command and receives a return value 42 with the appropriate checksum. The x-th instance X also requests the appropriate checksum via a query 44 of the checksum and receives a response 45.

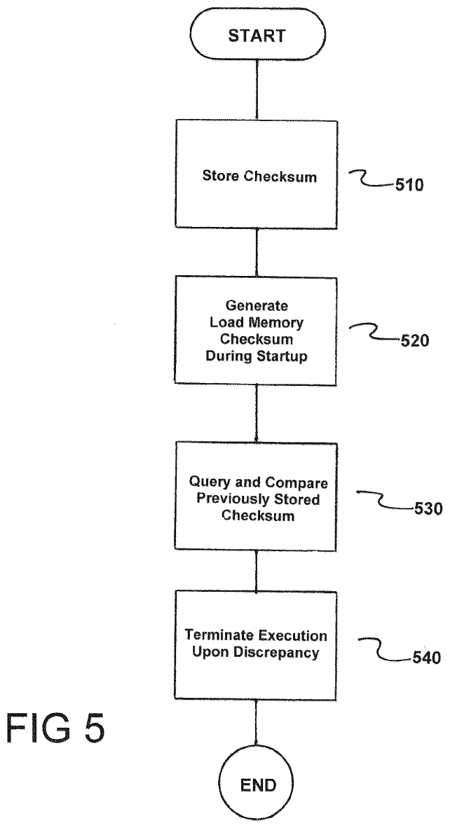

FIG. 5 is a flowchart of the method for operating control software Soft-PLC to control a process, where the control software Soft-PLC is executed within a runtime environment FW on a computer system 1, and a security program F-Prog is loaded into a load memory 10 to execute in the control software Soft-PLC.

The method comprises storing a checksum FCC-con of program code of the security program F-Prog in a network subscriber 3) that is connected to the computer system 1 via a communication network 2, as indicated in step 510.

Next, a load memory checksum FCC-act is generated during a startup of the control software Soft-PLC in the runtime environment FW via the program code of the security program F-Prog, which is stored in the load memory 10, as indicated in step 520.

Next, the previously stored checksum FCC-con is queried by the network subscriber 3 and the previously stored checksum FCC-con is compared with the load memory checksum FCC-act, as indicated in step 530.

Next, execution of the security program F-Prog in the control software Soft-PLC is terminated in an event of a discrepancy between the previously stored checksum FCC-con and the load memory checksum FCC-act, as indicated in step 540.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating control software to control a process, the control software being executed within a runtime environment on a computer system, and a security program being loaded into a load memory to execute in the control software, the method comprising:
storing a checksum of program code of the security program in a network subscriber which is connected to the computer system via a communication network;
generating a load memory checksum during a startup of the control software in the runtime environment via the program code of the security program, which is stored in the load memory;
querying the previously stored checksum by the network subscriber and comparing the previously stored checksum with the load memory checksum; and
terminating execution of the security program in the control software in an event of a discrepancy between the previously stored checksum and the load memory checksum.

2. The method as claimed in claim 1, wherein instances are generated by the runtime environment on one of the computer system and further computer systems, on which control software for controlling a process is executed in each case, and a security program is loaded in each case into a load memory, which is allocated to a respective instance, so as to execute in the respective control software;
wherein a utility is operated, which manages a storage of respective checksums of respective program codes of respective security programs;
wherein, during a startup of the respective control software, the respective checksum is requested in the respective instance via the utility, a load memory checksum is generated in the respective instance via program code of the respective security program, which is stored in the associated load memory, and is compared with the checksums which are queried via the utility; and
wherein execution of the respective security program in the respective control software is terminated in an event of a discrepancy between the load memory checksum generated in the respective instance and the checksums which are queried via the utility.

3. The method as claimed in claim 2, wherein a unique identification number is utilized in the utility when managing checksums of a plurality of program codes of the respective security programs for the respective control software.

4. The method as claimed in claim 1, wherein the checksum of the program code of the security program is copied and a redundant storage is set up, and the checksum or a checksum copy is stored on different network subscribers via the communication network.

5. The method as claimed in claim 2, wherein the checksum of the program code of the security program is copied and a redundant storage is set up, and the checksum or a checksum copy is stored on different network subscribers via the communication network.

6. The method as claimed in claim 3, wherein the checksum of the program code of the security program is copied and a redundant storage is set up, and the checksum or a checksum copy is stored on different network subscribers via the communication network.

7. The method as claimed claim 1, wherein the computer system is operated as one of a multifunctional control platform, an industrial PC, an edge computing platform and a cloud computing platform.

8. The method as claimed in claim 1, wherein an engineering system for downloading the security program is connected to the computer system, and the checksum of the program code of the security program is stored by one of the engineering system and the runtime environment.

9. The method as claimed in claim 1, wherein the control software is operated with the security program to control a process as a controller which is established for functional security, and security modules are operated in the control software having the security program to ensure processes that are required by the control software for functional security.

10. An arrangement comprising:
a computer system comprising a runtime environment which is configured to execute run control software to control a process;
a load memory stores a security program for execution in the control software;
a network subscriber connected to the computer system via a communication network, the network subscriber including a storage area in which a checksum of the program code of the security program is stored; and
a program identifier which is configured to generate a load memory checksum during a startup of the control software via the program code of the security program, which is stored in the load memory, and to query the checksum which is previously stored in the network subscriber and to compare the checksum with the load memory checksum, and furthermore configured to output an error signal which terminates the security program from being executed in the control software in an event of a discrepancy between the checksum with the load memory checksum.

11. The arrangement as claimed in claim 10, further comprising:
a first instance of the runtime environment on the computer system and a second instance of the runtime environment on one of the computer system and a further computer system, the first and second instances being configured to hold control software for controlling a process, in which a security program is loadable;
a first load memory and a second load memory in which the respective control software is loaded, one of the runtime environment and instances of the runtime environment being configured to load the security programs into the control software during a startup; and
a utility which is configured to manage a storage of the respective checksums of the respective program codes of the respective security programs, and configured to request the respective checksum during a startup of the respective control software in the respective instance;
wherein the respective instances are configured to generate a load memory checksum via the program code of the respective security program, which is stored in the associated load memory, and to compare the load memory checksum with the checksum which is queried via the utility; and
wherein execution of the respective security program in the respective control software is terminated in an event of a discrepancy between the load memory checksum with the checksum.

12. The arrangement as claimed in claim 11, wherein the utility is configured to allocate a unique identification number to the respective security programs for the respective control software when managing checksums of a plurality of program codes.

13. The arrangement as claimed in claim 10, further comprising:
a redundant storage in which a checksum copy of the checksum of the program code of the security program is storable.

14. The arrangement as claimed in claim 11, further comprising:
a redundant storage in which a checksum copy of the checksum of the program code of the security program is storable.

15. The arrangement as claimed in claim 12, further comprising:
a redundant storage in which a checksum copy of the checksum of the program code of the security program is storable.

16. The arrangement as claimed in claim 10, wherein the computer system is configured as one of a multifunctional control platform, an industrial PC, an edge computing platform and a cloud computing platform.

17. The arrangement as claimed in claim 10, further comprising:
an engineering system which is configured to at least one of download the security program and create the first and second instances.

18. The arrangement as claimed in claim 10, wherein the control software is configured with the security program to control a process as a controller that is configured for functional security, and security modules are present in the control software having the security program to ensure processes that are required by the control software for functional security.
